(19) United States
(12) Patent Application Publication
(10) Pub. No.: US 2009/0175048 A1
(43) Pub. Date: Jul. 9, 2009

(54) Lamp mounting seat

(76) Inventor: Woody Hwang, Norwalk, CA (US)

Correspondence Address: WEIDE & MILLER, LTD., 7251 W. LAKE MEAD BLVD., SUITE 530, LAS VEGAS, NV, 89128, US

(21) Appl. No.: 12/008,379

(22) Filed: Jan. 9, 2008

(51) Int. Cl. B60Q 1/00; F21V 19/02; H01R 24/00

(52) U.S. Cl. 362/487; 362/523; 439/699.2

(57) ABSTRACT

A lamp mounting seat is adapted for mounting a lamp on a lamp mounting frame of a vehicle. The lamp mounting frame includes a plate body formed with a mounting hole, and the lamp mounting seat includes a seat body and a retaining ring. The seat body includes a base wall and a surrounding wall, which cooperate to define a receiving space adapted for receiving the lamp therein. The surrounding wall includes first and second stop units and a plate engaging groove. The seat body is adapted to be extended through the mounting hole of the lamp mounting frame such that a periphery of the mounting hole is received in the plate engaging groove, thereby mounting the seat body in the mounting hole. The retaining ring is detachably mounted on the surrounding wall for preventing removal of the lamp from the receiving space.

### BACKGROUND OF THE INVENTION

1. Field of the Invention

This invention relates to a lamp mounting seat, more particularly to a lamp mounting seat adapted for mounting a lamp on a lamp mounting frame of a vehicle.

2. Description of the Related Art

FIG. 1 illustrates a conventional vehicle lamp mounting frame 12, commonly seen on the rear side of a vehicle body 11, such as that of a truck or a van. The lamp mounting frame 12 includes a plurality of mounting holes 120 (only one is shown in the drawing) and a plurality of lamp mounting seats 2 mounted therein. Vehicle lamps 13 mounted in the lamp mounting seats 2 are used to enable the driver to signal traffic advancing from behind.

Each lamp mounting seat 2 includes a seat body 21 for containing a vehicle lamp 13, and a retaining frame 22 disposed on the seat body 21 and provided with a plurality of fastener holes 220.

To mount the lamp mounting seat 2 on the vehicle lamp mounting frame 12, the seat body 21 must be placed into a corresponding mounting hole 120, and a plurality of screws 14 are passed through the fastener holes 220 in the retaining frame 22 and threadedly engage the lamp mounting frame 12 so as to secure the lamp mounting seat 2 to the lamp mounting frame 12. Since it is essential that the screws 14 be extended one by one through the fastener holes 220 in the retaining frame 22, and be threaded into the lamp mounting frame 12, the installation is time consuming, especially if many lamps 13 must be installed.

To replace the lamp 13, it is necessary to first loosen the screws 14 one by one to release the lamp mounting seat 2, then install a replacement lamp 13 in the seat body 21, then mount the seat body 21 in the mounting hole 120 of the lamp mounting frame 12, and finally, replace and tighten the screws 14. Thus, routine maintenance is also time consuming, particularly when performed by persons lacking skill or dexterity.

### SUMMARY OF THE INVENTION

Therefore, the object of the present invention is to provide a lamp mounting seat that is capable of overcoming the aforementioned drawbacks of the prior art.

According to the present invention, there is provided a lamp mounting seat adapted for mounting a lamp on a lamp mounting frame of a vehicle. The lamp mounting frame includes a plate body formed with a mounting hole. The lamp mounting seat comprises a seat body and a retaining ring.

The seat body includes a base wall and a surrounding wall extending from a periphery of the base wall and surrounding an axis. The surrounding wall cooperates with the base wall to define a receiving space adapted for receiving the lamp therein. The surrounding wall has an outer surface formed with first and second stop units that are spaced apart from each other with respect to the axis, and that cooperate with the outer surface of the surrounding wall so as to define a plate engaging groove thereamong. The first stop unit has a ramp surface that extends in radial outward directions from the outer surface of the surrounding wall toward the second stop unit.

The seat body is adapted to be extended through the mounting hole in the plate body of the lamp mounting frame such that a periphery of the mounting hole slides along the ramp surface of the first stop unit toward the second stop unit until the periphery of the mounting hole is received in the plate engaging groove, thereby mounting the seat body in the mounting hole.

The retaining ring is detachably mounted on one end of the surrounding wall opposite to the base wall for preventing removal of the lamp from the receiving space.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional lamp mounting seat for mounting a vehicle lamp on a vehicle lamp mounting frame;

FIG. 2 is a partly sectional, exploded, schematic side view of a preferred embodiment of the lamp mounting seat according to this invention;

FIG. 3 is a sectional, schematic side view of the lamp mounting seat of FIG. 2, illustrating the extension of the seat body into a mounting hole of a lamp mounting frame;

FIG. 4 is a partly sectional, schematic side view of the lamp mounting seat of FIG. 2, illustrating the seat body mounted in the mounting hole of the lamp mounting frame and a retaining ring mounted on the seat body; and

FIGS. 5 and 6 are perspective views of possible forms of stop units and an engaging portion of the seat body of the preferred embodiment of the lamp mounting seat according to this invention.

### DETAILED DESCRIPTION OF THE PREFERRED EMBODIMENT

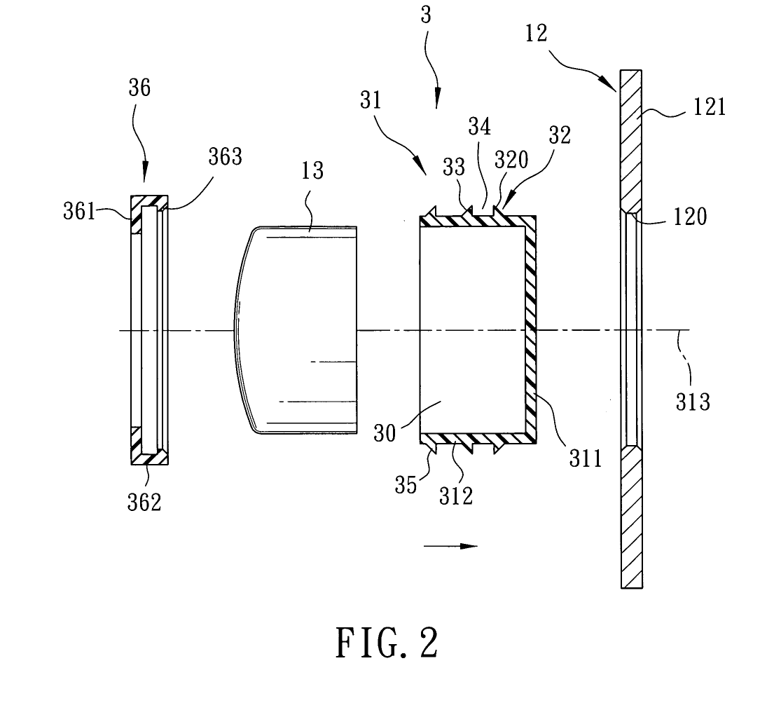

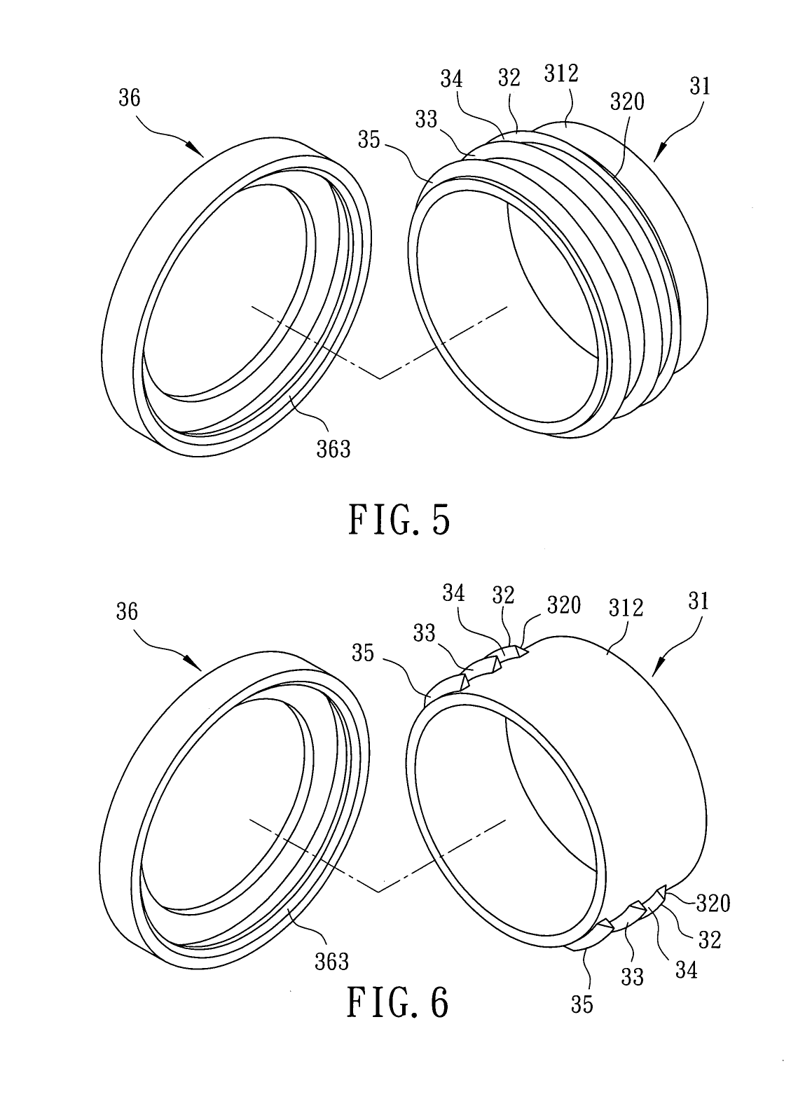

FIGS. 2 and 5 illustrate a preferred embodiment of a lamp mounting seat 3 according to this invention. The lamp mounting seat 3 is adapted for mounting a lamp 13 on a lamp mounting frame 12 of a vehicle. The lamp mounting frame 12 includes a plate body 121 formed with a mounting hole 120. The lamp mounting seat 3 comprises a seat body 31 and a retaining ring 36.

The seat body 31 includes a circular base wall 311 and a surrounding wall 312 extending from a periphery of the base wall 311 and surrounding an axis 313. The surrounding wall 312 cooperates with the base wall 311 to define a receiving space 30 adapted for receiving the lamp 13 therein. The surrounding wall 312 has an outer surface formed with first and second stop units 32, 33 that are spaced apart from each other with respect to the axis 313, and that cooperate with the outer surface of the surrounding wall 312 so as to define a plate engaging groove 34 thereamong. The first stop unit 32 has a ramp surface 320 that extends in radial outward directions from the outer surface of the surrounding wall 312 toward the second stop unit 33.

In this embodiment, the first and second stop units 32, 33 include annular protrusions formed around the outer surface of the surrounding wall 312 (see FIG. 5). Alternatively, one or both stop units 32, 33 may include angularly spaced apart radial protrusions formed on the outer surface of the surrounding wall 312 (see FIG. 6). However, the actual form and dispositions of the stop units 32, 33 are not limited to those shown in the drawings.

Returning to FIGS. 2 and 5, the retaining ring 36 is detachably mounted on one end of the surrounding wall 312 of the seat body 31 opposite to the base wall 311. Preferably, the end of the surrounding wall 312 is provided with a first engaging portion 35, and the retaining ring 36 includes an end ring segment 361 with an outer ring periphery, and a side ring segment 362 that extends parallel to the axis 313 from the outer ring periphery of the end ring segment, that is sleeved on said one end of the surrounding wall 312, and that is provided with a second engaging portion 363 for removably engaging the first engaging portion 35 of the surrounding wall 312.

In this embodiment, the first engaging portion 35 of the seat body 31 is an annular protrusion (see FIG. 5) formed around the outer surface of said one end of the surrounding wall 312, but it may also be designed as illustrated in FIG. 6, as angularly spaced apart radial protrusions formed on the outer surface of said one end of the surrounding wall 312 (only two are shown in FIG. 6). The actual forms of the engaging portions 35, 363 of the seat body 31 and the retaining ring 36 are not limited to the above stated forms.

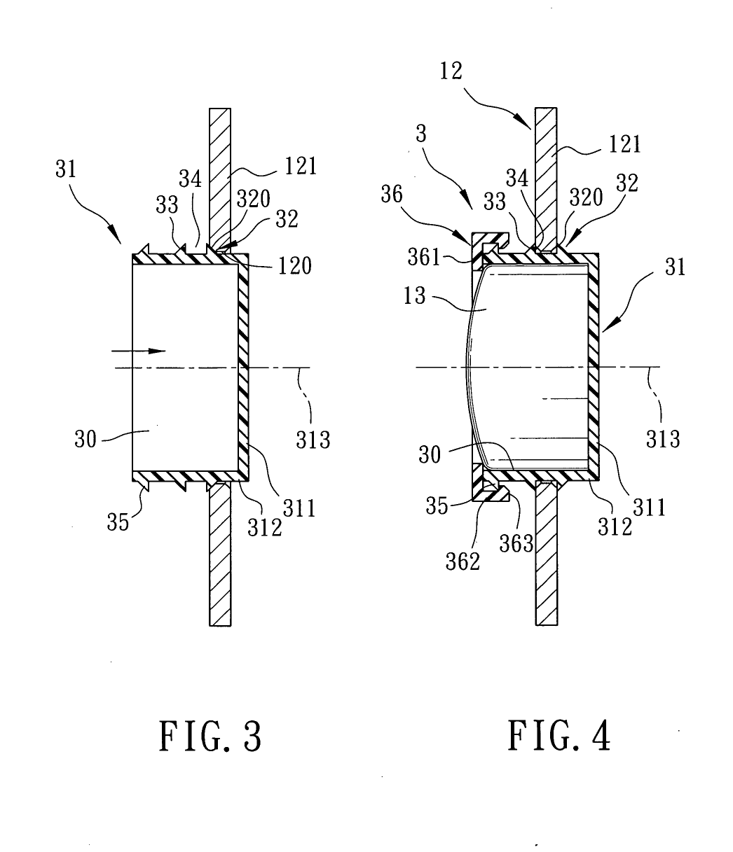

Referring to FIGS. 2, 3, and 4, in order to install the lamp mounting seat 3 on the lamp mounting frame 12, the seat body 31 must be extended through the mounting hole 120 (in the direction indicated by the arrows in FIGS. 2 and 3), such that a periphery of the mounting hole 120 engages and slides along the ramp surface 320 of the first stop unit 32 toward the second stop unit 33.

As the seat body 31 is progressively extended through the mounting hole 120, the periphery of the mounting hole 120 expands elastically as it slides along the ramp surface 320. When the periphery of the mounting hole 120 slides past the first stop unit 32, the periphery of the mounting hole 120 returns to its original dimensions, allowing the periphery of the mounting hole 120 to extend into the plate engaging groove 34 between the first and second stop units 32, 33, thereby arresting movement of the seat body 31 relative to the lamp mounting frame 12.

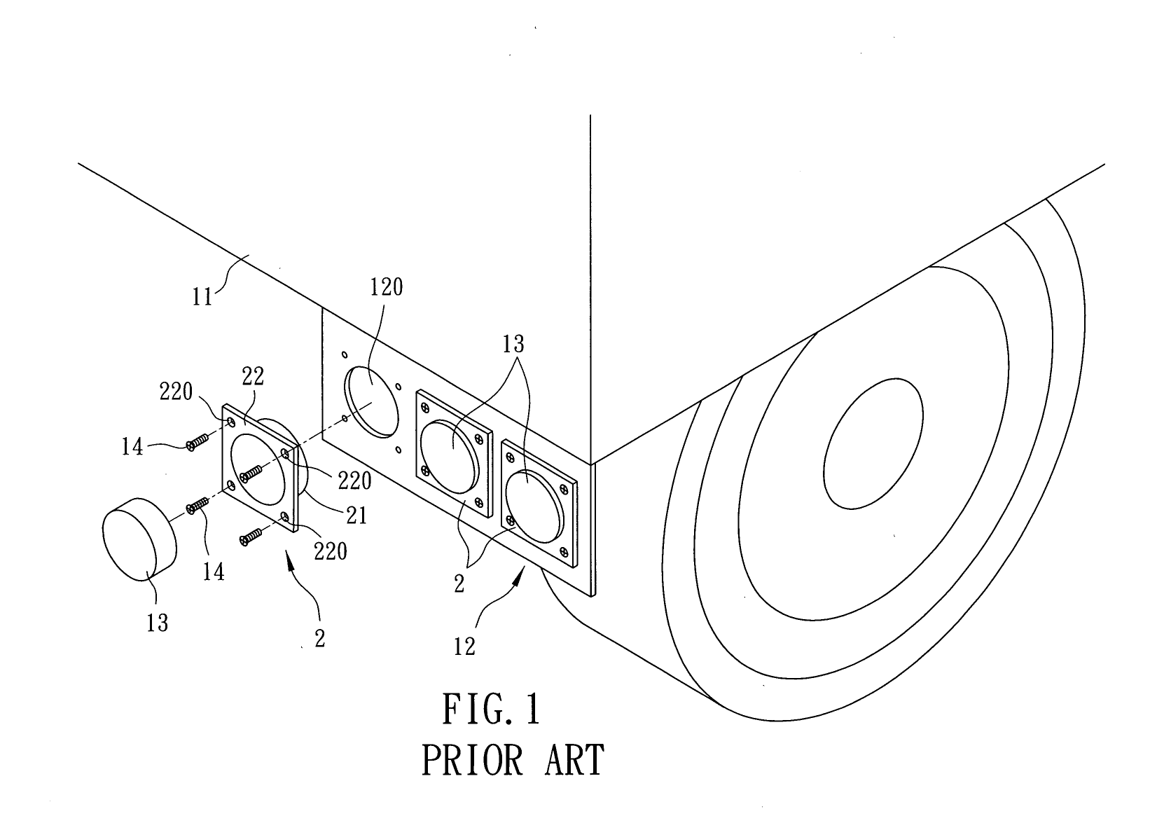

As detailed above, simply pushing the seat body 31 through the mounting hole 120 until the periphery of the mounting hole 120 is received in the plate engaging groove 34 effectively mounts the seat body 31 in the mounting hole 120 of the lamp mounting frame 12. Compared to the mounting of the conventional lamp mounting seat 2 of FIG. 1, the mounting of the lamp mounting seat of this invention does not require the use of screws 14. Instead, the elasticity of the periphery of the mounting hole 120 is utilized to secure the seat body 31 in the mounting hole 120 of the lamp mounting frame 12. Thus, installation of the lamp mounting seat 3 on the lamp mounting frame 12 is comparatively simpler and less time consuming.

In the preferred embodiment, the lamp 13 is placed in the receiving space 30 of the seat body 31, and the retaining ring 36 is mounted on one end of the surrounding wall 312 of the seat body 31 as described previously. The end ring segment 361 of the retaining ring 36 prevents the removal of the lamp 13 from the receiving space 30, while the opening defined by the inner ring periphery of the end segment 361 makes the lamp 13 externally visible.

When it is necessary to replace the lamp 13, the second engaging portion 363 of the retaining ring 36 may be disengaged from the first engaging portion 35 of the surrounding wall 312 by hand, so that the retaining ring 36 may be removed from the seat body 31 and a replacement lamp 13 may be placed in the receiving space 30. As a result, the disassembly required for routine maintenance is simple and therefore efficient.

It has thus been shown that the mounting of the lamp mounting seat 3 of this invention does not require the use of screws, and can be accomplished easily and quickly without the use of specific knowledge or skill.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A lamp mounting seat adapted for mounting a lamp on a lamp mounting frame of a vehicle, the lamp mounting frame including a plate body formed with a mounting hole, said lamp mounting seat comprising:
a seat body including a base wall and a surrounding wall extending from a periphery of said base wall and surrounding an axis, said surrounding wall cooperating with said base wall to define a receiving space adapted for receiving the lamp therein, said surrounding wall having an outer surface formed with first and second stop units that are spaced apart from each other with respect to the axis and that cooperate with said outer surface of said surrounding wall so as to define a plate engaging groove thereamong, said first stop unit having a ramp surface that extends in radial outward directions from said outer surface of said surrounding wall toward said second stop unit, said seat body being adapted to be extended through the mounting hole in the plate body of the lamp mounting frame such that a periphery of the mounting hole slides along said ramp surface of said first stop unit toward said second stop unit until the periphery of the mounting hole is received in the plate engaging groove, thereby mounting said seat body in the mounting hole; and
a retaining ring detachably mounted on one end of said surrounding wall opposite to said base wall for preventing removal of the lamp from said receiving space.

2. The lamp mounting seat as claimed in claim 1, wherein:
said one end of said surrounding wall of said seat body is provided with a first engaging portion; and
said retaining ring includes an end ring segment with an outer ring periphery, and a side ring segment that extends parallel to the axis from said outer ring periphery of said end ring segment, that is sleeved on said one end of said surrounding wall of said seat body, and that is provided with a second engaging portion for engaging removably said first engaging portion.

3. The lamp mounting seat as claimed in claim 1, wherein at least one of said first and second stop units includes an annular protrusion formed around said outer surface of said surrounding wall.

4. The lamp mounting seat as claimed in claim 1, wherein at least one of said first and second stop units includes a plurality of angularly spaced apart radial protrusions formed on said outer surface of said surrounding wall.
